(19) United States
(12) Patent Application Publication
(10) Pub. No.: US 2005/0267657 A1
(43) Pub. Date: Dec. 1, 2005

(54) Method for vehicle classification

(76) Inventor: Prashant P. Devdhar, Cupertino, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/120,651

(22) Filed: May 2, 2005

Related U.S. Application Data
(60) Provisional application No. 60/568,410, filed on May 4, 2004.

(51) Int. Cl. G06F 17/00

(52) U.S. Cl. 701/35; 701/1

(57) ABSTRACT

A technique for vehicle classification and identification from images successively narrows the classification of a vehicle down to vehicle make, model, and other specific characteristics. This process uses location, size, color, shape, and other image characteristics that help differentiate vehicles from other kinds of objects in an image. A broad categorization of the target vehicle is performed by classifying the vehicle according to a predetermined set of general vehicle types. A short list is then created of potential matching vehicle makes and models within the broad category that have the best chance of matching the target vehicle. Specific visible points on the target vehicle are identified and then a wire-frame matching with pre-recorded wire-frame models of the short listed vehicles is performed to produce a set of selected vehicle makes and models.

### CROSS-REFERENCE TO RELATED APPLICATIONS

This application claims priority from U.S. Provisional Patent Application 60/568410 filed May 4, 2004 which is incorporated herein by reference.

### FIELD OF THE INVENTION

This invention relates generally to methods for classification of vehicles using aerial, satellite, or ground-based imagery.

### BACKGROUND ART

Current state of the art in vehicle classification mostly relates to classification of vehicles using a ground-based infrastructure. Such infrastructure includes inductor sensors, weight sensors, ultrasonic sensors, interrogator-transponder systems, and RF identity transmitters and receivers. These systems, however, are generally very expensive to implement. Some vehicle classification techniques described in the literature require affixing items to vehicles. Examples of such items include holographic media and infrared radiation sensitive identification media inserted between windshield layers. This is a very costly process if applied to all automobiles and furthermore older vehicles that do not have the medium affixed cannot be classified using this technique. In addition, these techniques are limited to detecting vehicles at fixed locations where the ground-based infrastructure detectors are placed.

Some references in the literature suggest the possibility of spotting or detecting the mere presence of a vehicle from its surroundings in a aerial or satellite image. The mere detection of a vehicle, however, is of limited use.

### SUMMARY

In one aspect, the present invention provides vehicle classification techniques based on aerial, satellite, and/or ground-level imagery. In addition to identifying the presence of a vehicle, the techniques classify the vehicle by type, i.e., identify the vehicle as belonging to one or more specific vehicle makes and models. Identification of vehicle make, model, and other characteristics specific to a vehicle from aerial or satellite imagery has numerous applications in fields ranging from marketing, insurance underwriting, city planning, traffic management, and law enforcement. Statistical analysis of specific vehicle populations in an area can be used, for example, to indicate specific population characteristics such as income levels and other demographics.

Vehicle classification using these techniques does not require any costly ground-based infrastructure. The techniques do not require any media or transponder to be affixed to any vehicle. Furthermore, the techniques are independent of vehicle location. In addition, the techniques are flexible enough that they can be equally applied to images of vehicles taken from a wide variety of distances and angles.

In one aspect of the invention, a vehicle classification technique uses a hierarchical approach to successively narrow the classification of a vehicle down to vehicle make, model, and other specific characteristics. This approach significantly reduces the workload by successively narrowing down the set of potential matching vehicles just as the complexity of the matching process increases.

The hierarchical technique includes identifying from an image the presence of a target vehicle. This process may use location, size, color, shape, frequency response, and other characteristics that help differentiate vehicles from other kinds of objects in an image.

Once a target vehicle is identified in an image, the next step in the process is to classify the vehicle as belonging to a broad vehicle category. This broad categorization selects a particular general vehicle type from a predetermined set of general vehicle types. Broad vehicle categories may include, for example, the categories of minivans, sedans, pickup trucks, recreational vehicles, large vans, and sports utility vehicles. This broad categorization of the target vehicle may be performed by using information about the external and internal visible edges of the vehicle.

Once a broad category of the target vehicle is determined, the next step in the process is to create a short list of potential matching vehicle makes and models within the selected broad category that approximately match the target vehicle with respect to one or more vehicle characteristics. The short list may be created, for example, by determining the target vehicle's visible roof surface area and comparing that area with a pre-recorded roof surface areas of vehicle makes and models within the selected broad category of vehicles. Visible surface area is just one example of a differentiating characteristic that can be used to create a short list of potentially matching vehicle makes and models.

Once said short list of potentially matching vehicles is created, the next step in the process is to perform a wireframe matching between the target vehicle and predetermined wireframe models for vehicles in the short list. This wireframe matching may be performed by first identifying some specific visible points on the target vehicle. These specific visible points on target vehicle are tagged or named and then constrained to maintain their relative positions to each other so that they describe a spatial relationship that is visible on the surface of the target vehicle as seen from the camera. This spatial relationship is typically unique to a specific make and model of a vehicle. Then pre-recorded wire-frame models of the short listed vehicles are rotated through various angles to produce a most optimal fitting to the visible spatial relationship of the target vehicle. The fitting process may result in a match with one specific vehicle make and model; however, in some cases, the fitting process may yield more than one matching vehicle make and model. In such cases, various techniques may be used to further narrow the set. For example, the errors generated during the fitting process may be compared, and the errors used to select a single matching vehicle make and model having a smallest error. In another embodiment of the current invention, individual point displacements during the fitting process may be examined to determine a single matching vehicle make and model. The set of matching vehicles may also be narrowed by performing other corraborating and/or elimination tests to generate a final matching set. For example, vehicle paint color characteristics may also be determined from the image. Paint characteristics of said target vehicle may be obtained by determining paint characteristics of target vehicle at various points on the visible surface and then averaging the results or by sampling a location that best represents the color of said target vehicle or any other method that determines the paint characteristics of said target vehicle. Such paint characteristics could add another output data point when there is only one matching vehicle make and model. When there are more than one matching vehicle makes and model, paint color characteristics could be used in an attempt to further narrow down the matching vehicle to a single vehicle make and model. In addition, knowledge of specific make and models of vehicles with special features (e.g., front grilles, or unusual window shapes) can also be used to differentiate between various vehicles and to narrow down the set of potential matching vehicles.

In the event that all attempts to narrow down the potential matching vehicles to a single matching vehicle make and model fail, the target vehicle may be declared to have a chance to match any of the potential matching vehicles from the smallest set of potential matching vehicles.

### BRIEF DESCRIPTION OF THE FIGURES

FIG. 1A shows a flowchart of a process for classification of a target vehicle according to an embodiment of the present invention.

FIG. 1B is a diagram illustrating the successive narrowing which takes place in hierarchical vehicle classification according to an embodiment of the present invention.

FIGS. 2A, 2B, and 2C show a top view, as well as left and right side views, respectively, of a vehicle.

FIGS. 3A-3E are top views showing inside and outside edge lines of five general vehicle types (vehicle front is at bottom, rear is at top).

FIG. 4 shows a schematic of a top view of inside and outside edge lines of a vehicle used for calculating roof surface area.

FIG. 5 shows an isometric view of a wire-frame model of a vehicle.

FIG. 6 shows an aerial image of a vehicle with constraint points placed on the image.

FIG. 7 shows an aerial image of a vehicle with a wire-frame model of a matching vehicle superimposed.

### DETAILED DESCRIPTION

Although the following detailed description contains many specifics for the purposes of illustration, anyone of ordinary skill in the art will appreciate that many variations and alterations to the following details are within the scope of the invention. Accordingly, the following preferred embodiment of the invention is set forth without any loss of generality to, and without imposing limitations upon, the claimed invention.

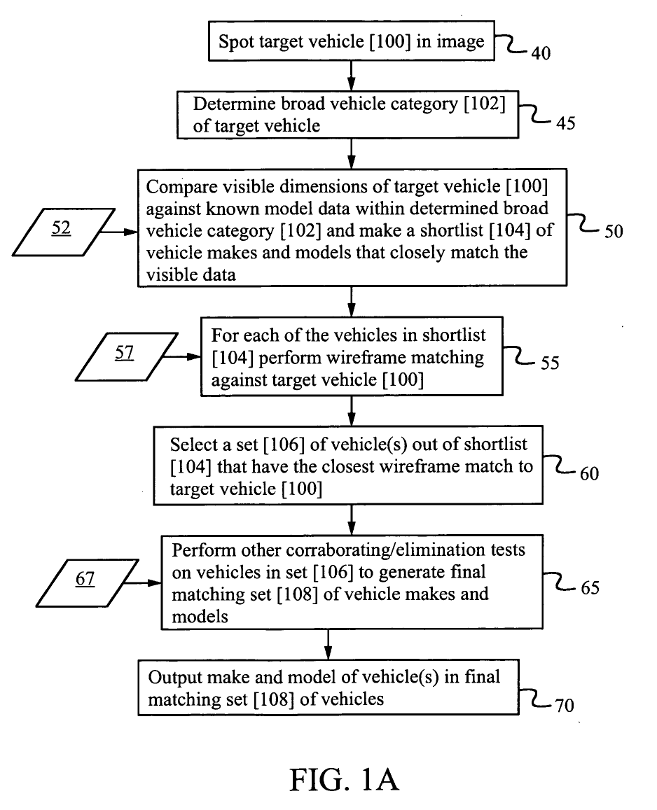

FIG. 1A shows a flowchart of a preferred embodiment of the current invention. To start the task of vehicle identification, an image is obtained. An example of an image could be an aerial image of an area, or an image of a vehicle taken at ground level. Any image where a vehicle can be seen would in general suffice to initiate the vehicle identification process. In a preferred embodiment, the image is stored in digital format on a computer-readable medium to facilitate computational image processing. In addition, subsequent steps in the method described below are preferably performed by computation. In some cases, steps may be preferably performed with user interaction to guide the classification process at various stages. The result of such a computer-implemented classification (with or without user interactivity) is a specification of at least one make a model of a vehicle in an image This output may be displayed, stored, and/or transmitted from the computer for various uses.

In Step 40 of the flowchart, a vehicle 100 is spotted in the image. Spotting target vehicle 100 can be accomplished in many ways, either manual, or automatic, or a combination thereof. Typically, a target vehicle 100 is distinguished from its surroundings by various characteristics such as its color, shape, size, and location. Most vehicles are located on streets, or driveways, or parking lots. Most vehicles have colors that stand out from their surroundings. In addition, most vehicles are reflective objects and reflect incident light in a very unique manner compared to other surrounding objects in the image. Vehicles can be distinguished from natural objects in the image due to their straight edges and corners. Vehicles can distinguished from other man-made objects in the image due to their unique reflective characteristics, colors, shape and/or size. For example, vehicles can be easily distinguished from houses due to size (houses are much larger than vehicles), reflectivity (houses don't reflect as much light as vehicles do), and color (house colors are usually very different than vehicle colors). Vehicles can be distinguished from road surfaces or driveway surfaces or parking lot surfaces due to their color and reflectivity. Road, driveway, and parking lot surfaces do not reflect as much light as vehicles do. In addition, vehicles can be easily identified from their surroundings due to their windshields, and/or wheels. Vehicles can be distinguished from other vehicles due to intervening non-vehicular space between them. Automatic feature extraction programs may be used for detecting presence of vehicles in a picture. These programs may be trained to detect the presence of vehicles by using a training set of vehicles. Such programs are most useful when the target image environment (angle, resolution) is very similar to the training environment. When a target vehicle is not clearly distinguishable from its surroundings, image enhancement techniques may be used to make it more clearly distinguishable. Pixellation of the image when the image is enlarged for viewing sometimes increases the difficulty of identifying vehicles. A blurring of the image, where the blurring is just enough to cause de-pixellation, significantly enhances the vehicle view. Brightness and contrast may also be changed to further enhance the image of the vehicle. Edge and corner detection techniques can also be used to detect vehicle edges and/or corners where such techniques are found superior to manual means of edge and corner detection.

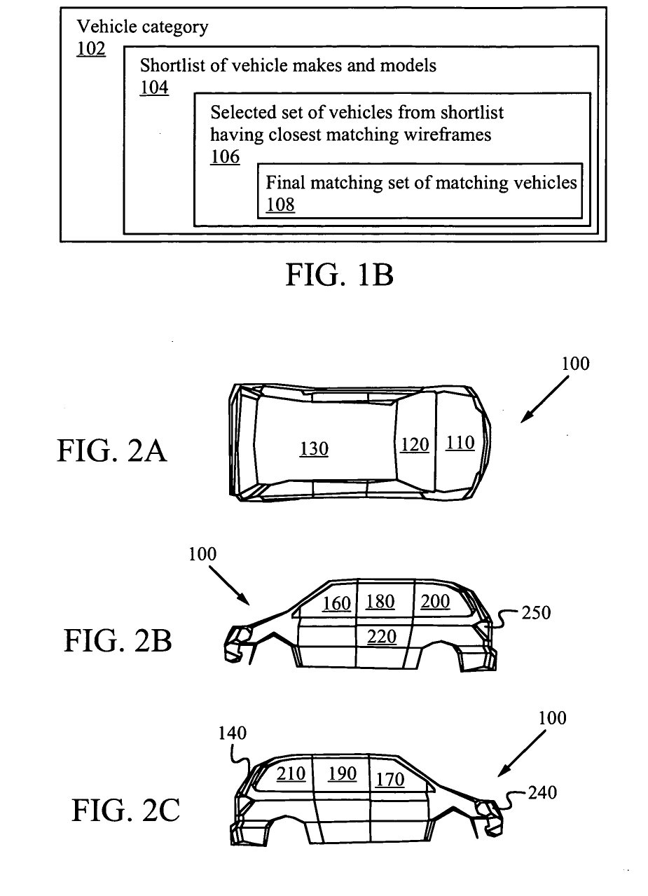

FIGS. 2A, 2B, 2C show a top and two side schematic views of a vehicle 100. As seen in these figures, vehicle 100 can be said to externally consist of several parts which include, a hood 110, a front windshield 120, a vehicle top 130, a rear windshield 140, a driver side front window 160, a passenger side front window 170, a driver side middle window 180, a passenger side middle window 190, a driver side rear window 200, and a passenger side rear window 210. In addition, vehicle 100 has several panels, including one or more door panels 220, one of more headlights 240 and one or more rear lights 250. Vehicles may have, in addition to or instead of the parts shown in these figures, a front grille, one or more side mirrors, a trunk, and one or more door handles. Vehicle 100 is characterized by (1) overall dimensions, which include overall length, width, and height, (2) vehicle profiles in various angles, (3) the length, width, height, shape and placement of each of the parts described above, (4) color, (5) luminosity and (6) other features including special features that no other vehicles may have.

Physical vehicle dimensions can be deduced by measurement of vehicle dimensions as seen in an image. Knowing the resolution of the image, the focal properties of the camera used in capturing the image, and the distance of the camera from the objects in the image, it is possible to deduce the physical dimensions of a vehicle in an image by measuring its dimensions in the image. Most Geographical Information Systems (GIS) software packages or other image modeling software already have modules in place that deduce the dimensions of any object in the image after knowing the resolution, focal properties of the camera, and the range from the camera to objects in the image. Some popular image formats, such as GeoTiff or MrSID, store such information along with the image to facilitate easy dissemination and use at the time of display and/or processing.

A vehicle profile is typically how the vehicle presents itself in an image. An aerial/satellite image generally presents vehicles in a straight top view or an angular top view. An image taken from the ground level on the other hand could present a vehicle from any angle other than the top views. Based on the view of the vehicle and the apparent angle from which the vehicle is seen in the image, it is possible to determine the front and rear ends of vehicle 100. Nearly all vehicles (the exception being full-forward vehicles such as buses and recreational vehicles) have a hood in the front. In a ground-based image, the hood is visible for a vehicle 100 when presented in a view from any angle except a view from a rear-only angle. The hood is distinguished due to its lower height compared to most of the rest of the vehicle. The hood side is clearly distinguished by its length from the trunk side. A hood is typically longer than a trunk. In addition, a hood side has front lights that are characterized by presence of white or clear glass. A tail side on the other hand, has tail lights which are characterized by red reflecting glass surfaces. A vehicle's front end has no lights with red reflecting glass surfaces. In an aerial/satellite image, the hood is clearly visible and is distinguished from the trunk by its length. A hood appears longer than a trunk. In addition, the front end of the vehicle in an aerial/satellite image is characterized by the presence of the front windshield. The front windshield usually has a longer length and a flatter gradient. The rear windshield on the other hand has a shorter length and a steeper gradient than the front windshield. The longer inherent length and the flatter gradient make the front windshield appear much larger in area and hence more visible in aerial/satellite images than the rear windshield. The front windshield, the hood, and head and tail lights, therefore present significant distinguishable characteristics to clearly distinguish the front of the vehicle from the rear of the vehicle when presented at most angles. For full-forward vehicles such buses, and recreational vehicles, it is possible to distinguish between the front and the rear ends by observing the front and rear lights, and/or by observing the front windshield, and/or by observing the locations of side-mirrors. In an image taken from ground level, a bus or an RV may be seen from any angle. A front windshield in a bus or an RV is typically angled for aerodynamic purposes. In addition, the front end has headlights that the rear end lacks. The rear end has tail lights with red reflecting surfaces that the front end lacks. The front end has driver side entry door and large side mirrors that the rear-end does not have. In an aerial/satellite view, the front end of a bus or RV is distinguished by the view of the larger front windshield compared to the smaller rear windshield and by presence of the side mirrors.

Once the front and rear ends of a vehicle are identified following the teachings above, a driver side and passenger side determination can be made depending upon the country where the vehicle was located. In countries where the driver sits on the left side of the vehicle the driver side will be the left side of the vehicle. In countries where the driver sits on the right side of the vehicle, the driver side will be the right side of the vehicle. In countries such as the United States, the left side of the vehicle is the driver side of the vehicle, while in countries such as the United Kingdom, the right side of the vehicle is the driver side of the vehicle. To simplify the present discussion, all references to driver side will be made with the United States driver side, i.e., the left side of the vehicle. It would be obvious to one skilled in the art that the foregoing discussion can be suitably altered to suit the needs of a right side driver location without departing from the spirit and scope of this invention.

Once the front, rear, driver, and passenger sides of a vehicle have been identified in the image by following the teachings above, the remaining vehicle panels can be identified based upon mechanical connections as shown for the exemplary vehicle in FIGS. 2A-C. A hood 110 is attached to a front windshield 120. Recognition of hood 110 and front windshield 120 is part of the process of recognizing the front and rear ends of a vehicle 100 and has been described earlier. A roof in a top view is a part of vehicle 100 that is immediately attached to the rear edge of front windshield 120. In a non-top view, a roof 120 is recognized as the top part of vehicle 100. A hood is attached on the driver side to a driver side front panel that goes around the driver side front wheel. Similarly, a hood is attached on the passenger side to a passenger side front panel that goes around the passenger side front wheel. On its front side, a hood is attached to a front grille and headlight fixtures 240. When visible, the headlight fixtures are characterized by clear glass panels that enclose light bulbs. On the driver side, front windshield 120 is attached to a driver side front door assembly. The driver side front door assembly includes the driver side front window on its top. On the passenger side, front windshield 120 is attached to a passenger side front door assembly. The passenger side front door assembly includes the passenger side front window on its top. Both the driver and passenger side front door assemblies are attached to roof 120 on their top.

A rear windshield and rear light fixtures characterize the rear end of a vehicle 100. A rear windshield 140 attaches to roof 120 on the rear edge of roof 120. A rear light panel 240 that includes the rear lights attaches to the bottom of rear windshield 140. Recognizing a rear windshield and rear light fixtures are part of the process of recognizing the rear end of a vehicle and are described above.

A front end of a vehicle is sufficiently differentiable from its rear end. The teachings of this description provide specifications sufficient to use an image of a vehicle that shows the front end of a vehicle from some angle, whether top, side, or front, or any angle in the three-dimensional space at the front of a vehicle and positively identify the visible side as either a front end or positively rule out the visible side being a rear end of a vehicle. Similarly, the teachings of this description provide specifications sufficient to use an image of a vehicle that shows the rear end of a vehicle from any angle, whether top, side, or front, or any angle in the three-dimensional space at the rear of the vehicle and positively identify the visible side as either a rear end of a vehicle or positively rule out the visible side being a front end of a vehicle. Furthermore, the teachings of this description provide specifications sufficient to differentiate a front end of the vehicle from its rear end using a view of a vehicle that is looking directly down at said vehicle. The teachings of this description also provide specifications sufficient to use an image of a vehicle taken from any angle and differentiate between the driver and passenger sides of a vehicle and to subsequently identify the main panels and part assemblies at the front and rear of a vehicle.

Once a target vehicle 100 is spotted in said image and its front and rear ends, as well as its driver and passenger sides have been identified, the next subtask as described in step 45 of the flowchart is to broadly categorize it into a vehicular type, such as a Minivan, or a Sedan, or a Pickup Truck, or a Sports Utility Vehicle (SUV), or a Recreational Vehicle (RV) or other such vehicular types. A preferred method of broad categorization of target vehicle 100 into a specific vehicle category is described now.

All vehicles have front windshields and driver and passenger side front door assemblies. Most vehicles also have some sort of a roof. Most vehicles also have rear windshields and rear light panels. However, considerable variation is found among different vehicle categories about parts that attach to driver and passenger side front door assemblies on each sides of vehicle 100. Such differences can be used to as part of the process of differentiating between broad vehicle categories.

For a sub-compact or a sports car, driver side front door assembly including the driver side front window is directly attached to a driver side rear panel that goes around a driver side rear wheel. The driver side rear panel may include a small driver side rear window. In the case of a sports car, the small driver side rear window may be much longer and aerodynamically angled than the rear window of a sub-compact. The passenger side front door assembly for a sub-compact or a sports car similarly is directly attached to a passenger side rear panel that goes around a passenger side rear wheel. The passenger side rear panel may include a small passenger side rear window. In the case of a sports car, the small passenger side rear window may be much longer and aerodynamically angled than the passenger side rear window of a sub-compact. The driver side rear panel and passenger side rear panel are then directly attached to the rear windshield and the tail light assemblies. There are only two door panels in a sub-compact or a sports car: driver side door panel and passenger side door panel. A sub-compact or sports car is thus characterized by the presence of only two door panels. In a top view, its shorter length differentiates a sub-compact or a sports car from vehicles of other categories. A sports car may also have a retractable roof. A retracted roof of a sports car would further differentiate it from other vehicles in an image.

For a sedan or a compact car, the driver side front door assembly that includes the driver side front window is attached to a driver side rear door assembly. The driver side rear door assembly includes the driver side rear window. Similarly on the passenger side, the passenger side front door assembly of a sedan or a compact car is attached to passenger side rear door assembly. The passenger side rear door assembly includes the passenger side rear window. In a an image, a sedan or a compact car can be differentiated from other vehicles by the presence of four door assemblies - two door assemblies, front and rear on passenger and driver sides of the vehicle.

For a minivan, the driver side front door assembly that includes the driver side front window is attached to driver side middle door assembly. The driver side middle door assembly includes the driver side middle window. On the passenger side, for a minivan, the passenger side front door assembly is attached to a passenger side middle door assembly. The passenger side middle door assembly includes the passenger side middle window. Further, for a minivan, the driver side middle door assembly is attached on its rear side to a driver side rear panel that goes around the driver side rear wheel. The driver side rear panel includes a driver side rear window. On its passenger side, the minivan has attached to the rear side of the passenger side middle door assembly, a passenger side rear panel that goes around the passenger side rear wheel. The passenger side rear panel includes the passenger side rear window. In an image, a minivan is differentiated from vehicles of other categories by its longer length, and the presence of two middle door assemblies, one each on driver and passenger side of the vehicle.

For a single-cab pickup truck, the driver side front door assembly that includes the driver side front window is attached to a driver side cab panel that extends all the way to the rear. Similarly on the passenger side, the passenger side front door assembly of a single-cab pickup truck is attached to passenger side cab panel that extends all the way to the rear of the vehicle. The two cab panels along with the rear panel enclose the vehicle's cargo-carrying area. In a an image, single-cab pickup truck can be differentiated from other vehicles by the presence of twp door assemblies on passenger and driver sides of the vehicle by the presence of two long cab panels enclosing the cargo carriage area and by the lack of any rear windows.

For a double-cab pickup truck, the driver side front door assembly that includes the driver side front window is attached to driver side mid panel that includes a small mid driver side window. The driver side rear panel then is attached to a driver side cab panel that extends all the way to the rear. Similarly on the passenger side, the passenger side front door assembly of a single-cab pickup truck is attached to passenger side mid panel that includes a small mid passenger side window. The passenger side rear panel then is attached to passenger side cab panel that extends all the way to the rear of the vehicle. The two cab panels along with the rear panel enclose the vehicle's cargo-carrying area. In a an image, a double-cab pickup truck can be differentiated from other vehicles by the presence of two door assemblies on passenger and driver sides of the vehicle by the presence of two long cab panels enclosing the cargo carriage area and by the presence of two small mid-panel windows.

Substantial differences also exist in the dimensions of vehicles belonging to various broad categories of vehicles. Considering the dimensions data of various categories of vehicles, average length of a vehicle is about 188 inches, average width of a vehicle is about 71 inches, and average height of a vehicle is about 60 inches.

Following table illustrates the relative differences between the overall dimensions of vehicles belonging to five exemplary broad categories of vehicles as compared to average dimensions of all vehicles.

TABLE 1

| | | | | Compares | Compares | Compares |
|---|---|---|---|---|---|---|
| | | | | with other | with other | with other |
| Vehicle | Average | Average | Average | Vehicle | Vehicle | Vehicle |
| Category | Length | Width | Height | Lengths | Widths | Heights |
| Sedan | 190 | 71 | 57.5 | Longer | Same | Higher |
| SUV | 188 | 77.3 | 70.6 | Same | Wider | Higher |
| Minivan | 201.2 | 75.6 | 68.5 | Longer | Wider | Higher |
| Sports | 162.2 | 68.9 | 50 | Lot Smaller | Narrower | Lot Shorter |
| Car | | | | | | |
| Sub- | 174.7 | 66.7 | 55.1 | Smaller | Narrower | Shorter |
| compact | | | | | | |

As can be seen from Table 1, the exemplary broad categories of vehicles display strong relative deviations from the average dimensions of a vehicle. As described earlier, actual vehicle dimensions can be calculated by measuring vehicle dimensions in an image. Vehicle dimensions therefore form an important part of determining the broad category of a target vehicle 100.

Top views of vehicles also can be effectively used to identify a broad category to which a target vehicle 100 belongs. The internal edges visible in an image of a top view of a vehicle give information about hood, front windshield, roof, rear windshield, and trunk dimensions. Similar to deviations in overall dimensions between categories of vehicles, internal panel dimensions also show substantial deviation between categories of vehicles.

Internal edges of a vehicle can be identified in an image due to differences in coloring, surface angles, shadows, or luminosity of the materials used in manufacturing of various parts. A hood, a roof, and a trunk of a vehicle are generally metallic and hence display luminosity that is characteristic of a metal surface. The front and rear windshields on the other hand are made of clear or slightly tinted glass and hence they appear substantially different than the metallic parts of a vehicle. The hood and trunk generally slope down while a roof of a vehicle is generally flatter. Looking down on a vehicle, the metallic parts can be easily differentiated from the glass parts. Hoods are separated from roofs by the glass front windshield thereby creating two internal edges in the process, namely the edge between the hood and the front windshield, and the edge between the front windshield and the roof. Similarly, a rear windshield usually acts as a separator between the roof and the trunk, thereby again creating two internal edges, namely, the edge between the roof and the rear windshield, and the edge between the rear windshield and the trunk of a vehicle. For pickup trucks, the abrupt change of height from the roof to the base of the cargo holding area creates a shadow or a luminosity difference that identifies another internal edge, namely that between a roof and the cargo-holding area.

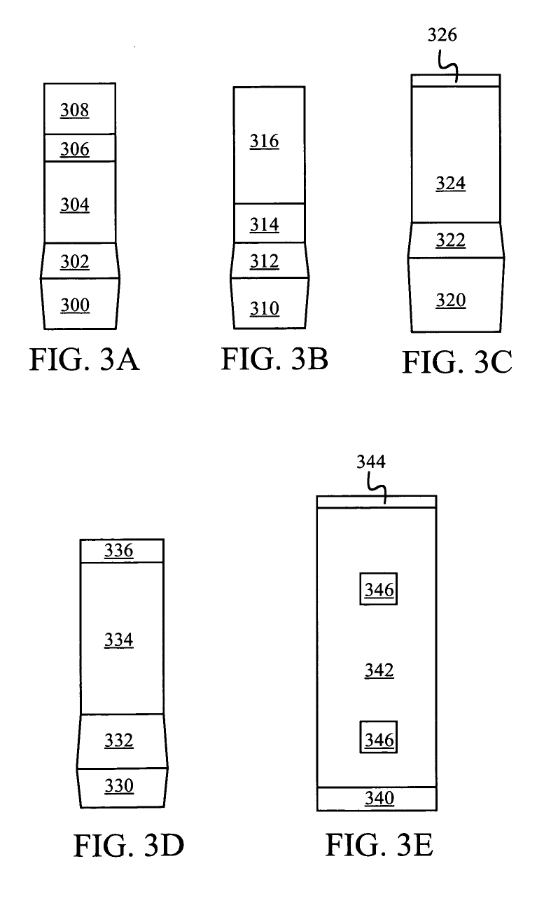

These internal edges identified in accordance with the teachings above separate various visible parts from each other. The relative dimensions of these visible parts can be compared to identify a broad category of vehicles to which a target vehicle 100 belongs. FIGS. 3A-E show exemplary top views of various broad types of common vehicles. FIG. 3A shows a top view of a Sedan. As can be seen in FIG. 3A, a Sedan can be characterized to have a hood 300, a front windshield 302, a roof 304, a rear windshield 306, and a trunk 308. A Pick-up truck, as seen in FIG. 3B, is seen to have a hood 310, a front windshield 312, a relatively smaller roof 314 as compared to that of a Sedan, and a holding area or bed 316. Its rear windshield is not visible in a top view as it is vertical. FIG. 3C shows a Sports Utility Vehicle (SUV). An SUV is seen to have a relatively longer hood 320 as compared to that of a Sedan, a front windshield 322, a relatively longer roof 324 as compared to that of a Sedan, a very short rear windshield 326 as compared to that of a Sedan, and no trunk. FIG. 3D shows a minivan, which is seen to have a a relatively shorter hood 330 as compared to those of a Sedan and an SUV, a windshield 332 that is relatively longer than those of a Sedan and an SUV, a relatively longer roof 334 as compared to that of a Sedan, a very short rear windshield 336 as compared to that of a Sedan, but relatively longer as compared to an SUV, and (similar to an SUV) it has no externally visible trunk. FIG. 3E shows a Recreational Vehicle (RV), which has no visible hood, a very little front windshield 340 as compared to those of other vehicle types, a relatively very wide and long roof 342, a relatively very little rear windshield 344 as compared to those of other vehicle types. An RV also shows one or more Air-conditioning or Heating vents 346 on the top that other vehicle types do not normally have.

As described above, vehicle populations can be grouped into broad categories of vehicles. Vehicles belonging to a broad category of vehicles generally display close similarities in their external dimensions, the relative dimensions of their visible parts, and their overall profiles. Similarly, vehicles belonging to different categories of vehicles show distinguishable differences in their images to sufficiently identify them as belonging to a particular category of vehicles. The teachings of this description provide specifications sufficient to use an image of a vehicle taken from any angle in the three-dimensional space surrounding the said vehicle, and from that image to identify the vehicle as belonging to a broad category of vehicles by (1) using the dimensions of a vehicle and comparing them to known dimensions of various categories of vehicles, or by (2) identifying various vehicle panels and/or part assemblies and/or structures present on the said vehicle and comparing them to known vehicle categories, or by (3) identifying internal edges of a vehicle by utilizing differences in coloring, luminosity, shadows and other distinguishing characteristics and comparing the parts thus formed by said internal edges and comparing said parts and their relative dimensions to known parts and relative dimensions of various categories of vehicles, or by (4) utilizing any distinguishing features present only on a particular category of vehicles, such as exhaust vent assemblies on top of Recreational Vehicles, or by (5) using any combinations of methods described earlier, or by (6) any other method or combination of methods.

FIG. 1B is a diagram illustrating broad vehicle category 102. Contained within broad category 102 are narrower subsets, as will be described in more detail below. The broad category 102 of vehicles may include but is not restricted to, Sedans, Pickup trucks, Sports Cars, Sports Utility Vehicles, Minivans, Vans, Recreational Vehicles, Buses, and Trucks. Many more and other categories 102 can be created that utilize relative differences in shapes, placements, and dimensions of various external parts of vehicles 100.

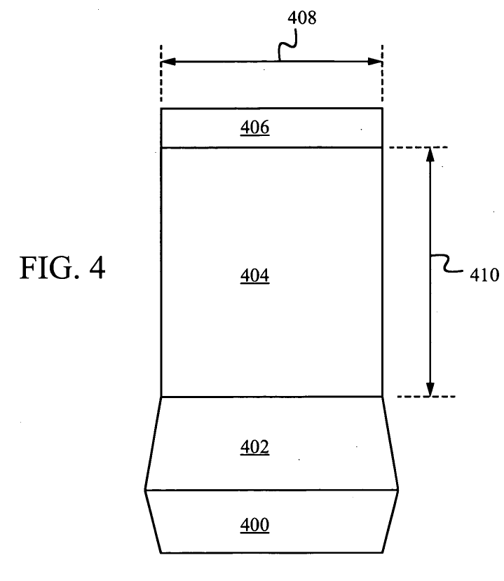

Step 50 of flowchart describes further steps towards reducing the number of vehicles that possibly match target vehicle 100. Vehicles can be further differentiated into a shortlist 104 of vehicles by calculating visible surface or panel areas and them comparing those numbers with corresponding and known surface or panel areas of vehicles included in said broad vehicle category 102. FIG. 4 shows as an example, a top view of a vehicle 100 having hood 400, front windshield 402, roof 404, and rear windshield 406. The width 408 and length 410 dimensions of vehicle 100 as seen in the image can be used to calculate the area of the visible surface of the roof 404 of vehicle 100. The roof surface area thus calculated can be compared against previously calculated roof surface areas of various vehicles that belong to said broad category 102 stored in data store 52. Within the broad category 102, another smaller grouping of vehicles may match the said calculated area even closer. Similarly, front windshield dimensions can be used to calculate visible surface area of the front windshield 402 of a vehicle 100. Comparing said surface area of front windshield against known surface areas of front windshields of vehicles belonging to said broad vehicle category 102 may yield a small subset of vehicles with front windshield areas that closely match the said calculated surface area of said front windshield of said target vehicle 100. Such smaller grouping of vehicles, a shortlist 104, contains vehicles that more closely resemble target vehicle 100 in broad external dimensions. Table 2 below shows dimensions of some exemplar minivans of 2003 and 2004 model years. Table 2 shows that even though a category of vehicles has very similar external dimensions, the vehicles within the category show some variation in the dimensions. These variations in single-dimensional quantities such as length L, width W, and height H, and double-dimensional quantities such as total visible surface area, total visible roof surface area, total visible front windshield area, or areas of other distinguishable panels can be used to identify a smaller subset within the said broad category of vehicles 102 to which said target vehicle 100 is most likely to belong.

TABLE 2

| | | Length | Width | Height | Mean Variation | Mean Variation |
|---|---|---|---|---|---|---|
| | | L | W | H | of Perimeter P | of Top area A |
| Make & Model | Year | (inches) | (inches) | (inches) | (inches) | (sq. inches) |
| Mazda MPV | 2003 | 187.8 | 72.1 | 69.1 | −21.80 | −1192.12 |
| Pontiac Montana | 2003 | 187.3 | 72.7 | 67.4 | −21.64 | −1115.79 |
| Mazda MPV | 2004 | 189.5 | 72.1 | 68.7 | −18.44 | −1069.55 |
| Toyota Sienna | 2003 | 194.2 | 73.4 | 67.3 | −6.44 | −478.22 |
| Pontiac Montana-ext | 2003 | 200.9 | 72 | 68.1 | 4.14 | −267.70 |
| Olds Silhouette | 2003 | 201.4 | 72.2 | 68.1 | 5.54 | −191.42 |
| Chevrolet Astro | 2003 | 189.8 | 77.5 | 75 | −7.04 | −23.00 |
| Chrysler Voyager | 2003 | 189.1 | 78.6 | 68.9 | −6.24 | 130.75 |
| Dodge Caravan | 2003 | 189.3 | 78.6 | 68.9 | −5.84 | 146.47 |
| Honda Odyssey | 2003 | 201.2 | 75.6 | 68.5 | 11.94 | 478.21 |
| Ford Windstar | 2003 | 201.5 | 76.6 | 66.1 | 14.54 | 702.39 |
| Toyota Sienna | 2004 | 200.0 | 77.4 | 68.9 | 13.14 | 747.49 |
| Chrysler | 2003 | 200.5 | 78.6 | 68.9 | 16.54 | 1026.79 |
| Town&Country | | | | | | |
| Nissan Quest | 2004 | 204.1 | 77.6 | 71.9 | 21.74 | 1105.65 |

Table 2 above contains pre-calculated information about vehicle top perimeter P=2(L+W), and vehicle top area A=LW(length)×(width) of various exemplary minivan makes and models of 2003 and 2004 model years. Similar information can be pre-calculated about other quantities and stored in data store 52 for comparison with observed vehicles in an image. Mean vehicle perimeter of the exemplary vehicles in Table 2 is about 541 inches. Mean vehicle top surface area of the exemplary vehicles in Table 2 is about 14,732 sq. inches. As can be seen there is a deviation of about 7.7% (about 3.8% each in positive and negative directions) about the mean in the case of vehicle top perimeter, and a deviation of about 15.5% (about 7.8% each in positive and negative directions) about the mean in the case of vehicle top surface area. Vehicle short-lists can be created using statistical methods based on dimensional data of vehicles and using grouping analysis. Dimensions of target vehicle 100 as deduced from the measurements in the image can then be used to put said target vehicle 100 in one of the said pre-determined short-lists. Another method of assigning a target vehicle 100 to a short-list of vehicles within a broad category 102 of vehicles would be to dynamically select a local group of vehicles from within the broad category 102 of vehicles that have comparable perimeter and top surface area measurements using a pre-determined selection criterion. One example of such criterion would be to select all vehicles that have either the perimeter or the top surface area or both within a quarter of the total deviation of the perimeter or the top surface area or both, respectively. There are many other ways of deciding what constitutes close resemblance between vehicles and many other selection criteria can be devised that help in reducing the size of the set of vehicles that potentially match target vehicle 100. Such methodical reduction in number of possible matching vehicles, either carried out using relative differences in shape, placement, and dimensions as described in the example above, or by any other means, including means such as direct visual evidence of special fittings, or past experience, narrows down the set of comparison vehicles that are most likely to match a target vehicle 100.

The teachings above provide specifications sufficient to differentiate a vehicle from other objects in an image, to identify various parts, panels, assemblies, and/or structures on the vehicle, to identify the front and rear sides of said vehicle, to identify the driver and passenger sides of said vehicle, to identify a broad category of vehicles to which the said vehicle belongs, and to identify a short-list within the said broad category of vehicles to which the said vehicle most closely resembles. This information is then used in the next step, step 55 of flowchart, where wire-frame models of possible comparison vehicles in shortlist 104 (see FIG. 1B) are used to further narrow down the set of likely matches to target vehicle 100.

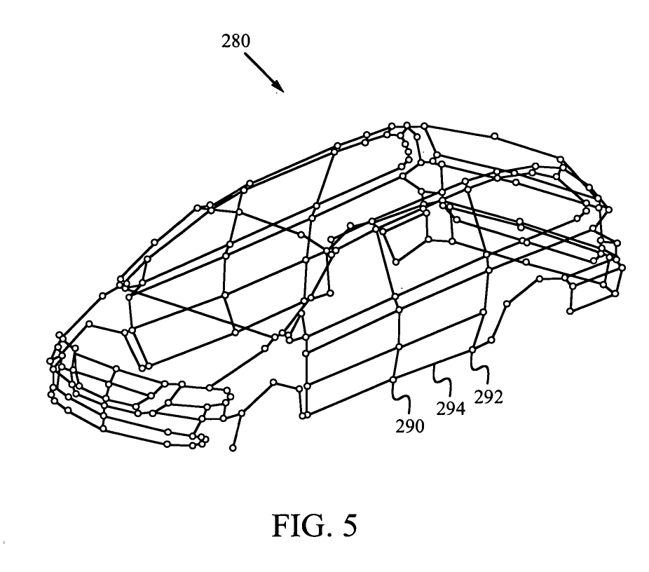

FIG. 5 shows an isometric view of a wire-frame model 280 of a vehicle. Model 280 includes a set of points in three-dimensional space (e.g., points 290 and 292) and a set of line segments connecting pairs of the points (e.g., line 294). Current state of the art describes several ways of how to make a wire-frame model of a vehicle. A wire-frame model of a vehicle can be made from as few as two or three photographs of a vehicle taken from different angles. One such application capable of creating wire-frame models using photographs is called Photomodeler. Other sophisticated methods require the presence of a vehicle in which a device is guided along the vehicle in a grid pattern noting the positions of various points along the way. A wire-frame model can also be acquired from the makers or manufacturers of a vehicle or from design shops and/or bureaus that specialize in selling wire-frame models. The existing, and/or prepared, and/or acquired wire-frame models of vehicles are used in the present technique as one of the steps of a vehicle identification and classification system. Preferably, all known available wire-frame models of vehicles are stored in data store 57, as shown in the flowchart in FIG. 1A. A wire-frame model 280 shows the connectivity of various points on a vehicle, the dimensions and shapes of various external features of a vehicle, as described above. A wire-frame model 280 does not describe color, or luminosity information of said vehicle. A wire-frame model is a three-dimensional representation of external vehicle parts and therefore can compared with the external vehicle parts of a target vehicle 100 in a process of matching. In order to facilitate this wire-frame matching, specific points of interest on target vehicle 100 in an image are first identified and named, as will now be described.

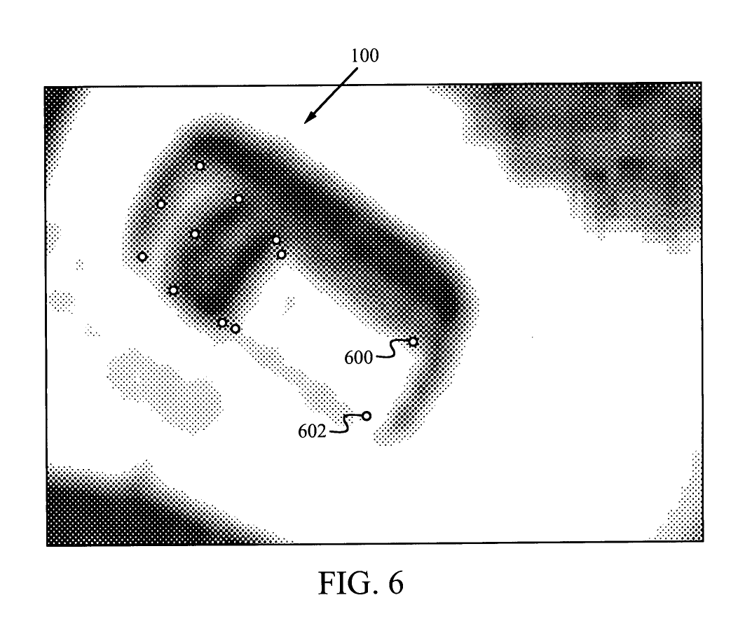

FIG. 6 shows an aerial image of a target vehicle 100 on which specific points of interest have been marked (e.g., points 600 and 602). Each point of interest in each wire-frame model 280 is named to facilitate comparison with the same point to be identified on a target vehicle 100. Such points of interest could be points of intersections of important panels, such as top of the driver side and passenger side front windshields, or bottom of the driver side and passenger side front windshields. A common naming convention is preferably used to facilitate identification of the same points on target vehicle 100 and comparison wire-frame model 280. Using tools such as Photomodeler or ArcGIS, or other image processing tools, it is possible to mark points of interest on a target vehicle 100 and either compare the resulting data for match against said comparison wire-frame model 280, or to store the resulting data in a file for a comparison process to be carried out against various other comparison wire-frame models 280 belonging to short-list 104. Using the process described earlier, various parts, panels, assemblies, and structures on target vehicle 100 are already identified. In addition, using the process described earlier, the front and rear sides of target vehicle 100, and the driver and passenger sides of target vehicle 100 are identified. There are many points of interest that could be possibly marked on a target vehicle 100, however, not all of those points will be visible in an image. Table 3 below contains an exemplary list of possible points of interest that can be marked on a target vehicle 100. The terms Top, Bottom, and Center will be used to properly differentiate between points of interest when points of interest lie on a part or panel that is angled with respect to the horizontal, for example, the front and rear windshields.

TABLE 3

| Front/ | Top/Bottom/ | Driver/Passenger | Part/Panel | Point |
|---|---|---|---|---|
| Back | Center | Side Or Middle | Name | Identifier |
| Front | Top | Driver Side | Windshield | FtdsWind- |
| | | | | shield |
| Front | Top | Passenger Side | Windshield | FtpsWind- |
| | | | | shield |
| Front | Bottom | Driver Side | Windshield | FbdsWind- |
| | | | | shield |
| Front | Bottom | Passenger Side | Windshield | FbpsWind- |
| | | | | shield |
| Front | Bottom | Driver | Hood | FbdsHood |
| Front | Bottom | Passenger | Hood | FbpsHood |
| Front | | Driver | Roof | FdsRoof |
| Front | | Passenger | Roof | FpsRoof |
| Back | | Driver | Roof | BdsRoof |
| Back | | Passenger | Roof | BpsRoof |
| Back | Top | Driver | Windshield | BtdsWind- |
| | | | | shield |
| Back | Top | Passenger | Windshield | BtpsWind- |
| | | | | shield |
| Back | Bottom | Driver | Windshield | BbdsWind- |
| | | | | shield |
| Back | Bottom | Passenger | Windshield | BbpsWind- |
| | | | | shield |
| Back | Bottom | Driver | Trunk | BbdsTrunk |
| Back | Bottom | Passenger | Trunk | BbpsTrunk |
| Front | Top | Middle | Windshield | FtmidWind- |
| | | | | shield |
| Front | Bottom | Middle | Windshield | FbmidWind- |
| | | | | shield |
| Back | Top | Middle | Windshield | BtmidWind- |
| | | | | shield |
| Back | Bottom | Middle | Windshield | BbmidWind- |
| | | | | shield |
| Front | Top | Middle | Grille | FtmidGrille |
| Front | Bottom | Middle | Grille | FbmidGrille |
| Front | Center | Driver | Wheel | FcdsWheel |
| Front | Center | Passenger | Wheel | FcpsWheel |

As mentioned earlier, only a subset of the possible points of interest are normally visible in the image of target vehicle 100.

Table 3 contains only examples of possible points of interest on a target vehicle 100. Many other possible points of interests can identified and marked over an image of a target vehicle 100. Similarly, the naming convention used above is just one of many possible naming conventions. Clearly, many other naming conventions can be devised that seek to uniformly name each point of interest on target vehicle 100 and its morphologically corresponding point on all comparison wire-frame models 280.

For comparison of a target vehicle 100 with a wire-frame model 280, it is sufficient to identify only a few points of interest on target vehicle 100. Although a minimum of one point is required to generate results, it is preferable to identify a minimum of three points on target vehicle 100 in order to produce a more reliable match. Typically, more than three points can be identified on an image of target vehicle 100. The more points identified and marked on target vehicle 100, the more reliable the matching process becomes. Adding more points of interest, however, may increase the time to calculate matches. Thus, the use of any additional points beyond what is necessary may unnecessarily consume processing time. It is also advisable to mark and identify points that are spread out in three dimensions over the body of the target vehicle 100 as seen in an image. Having points in three dimensions marked on target vehicle 100 allows the matching process to accurately determine the orientation of target vehicle 100 with respect to the camera. Accurate determination of the orientation of the target vehicle 100 helps in increasing the reliability of the matching process. Accurate determination of the target vehicle 100 orientation also help reduce the processing time, as the matching process is not forced to rotate the points of interest identified and marked on target vehicle 100 in three dimensions in attempts to match the three-dimensioned geometry of the comparison wire-frame model 280.

The wire-frame comparison or matching process starts from one of the marked points on the target vehicle and compares the distances and angular orientations of other points on target vehicle 100 with corresponding points located in comparison wire-frame model 280. The comparison process is often complex and repetitive. The process starts by constraining a first point on target vehicle 100 to a corresponding named point on comparison wire-frame model 280 and then attempting to match other points. A neighboring point on target vehicle 100 will be termed as matched if it is located within a certain pre-defined threshold of the corresponding named point on comparison wire-frame model 280. A threshold may be selected based upon a desired degree of accuracy of the process of identification. The threshold may also depend on the accuracy of the marking of points of interest on target vehicle 100 and also on the accuracy of the wire-frame model. A low-resolution image can make it harder to accurately identify and mark a point of interest on target vehicle 100 and therefore a more relaxed threshold may need to be selected in order for the matching process to yield a useful result. A high-resolution image, on the other hand, may make it possible to identify and mark points of interest on a target vehicle 100 more accurately as compared to what their real position is, and therefore a tighter threshold can be selected that results in tighter and more reliable match result. However, a very high-resolution wire-frame model would mean that tighter and tighter thresholds could be placed during the matching process depending upon the resolution of the image containing target vehicle 100. In practice, a threshold that matches the resolution of the image, for example a six-inch resolution image of a vehicle, will mean that each pixel on the image will indicate the intensity and color of light reflected by a 6 inch square portion of the vehicle. In this case, the highest resolution that can be used to identify and mark a point on the 6-inch resolution image of the vehicle is 6 inches. If a wire-frame model is of higher accuracy, then some tolerance may be provided to help produce a successful result of the matching process. In the best possible case of identifying and marking a point on a 6-inch resolution image, an error of 6-inches at worst can be made, assuming that the point was identified accurately and marked without any placement error. In the worst case of identifying and marking a point on a 6-inch resolution, an error of much more than 6 inches can be made, as the resolution error will be compounded by placement error. Hence a 6-inch tolerance threshold would be a tight threshold for comparing a target vehicle 100 as seen in an image of 6-inch resolution. However, in the example above, if the resolution of the comparison wire-frame model is itself at 1 ft resolution, then a 6-inch tolerance setting may result in failure to match in a majority of target vehicles. Thus setting the tolerance level would

A selected threshold preferably remains unchanged during the entire comparison process between target vehicle 100 and comparison wire-frame models 280 of vehicles belonging to short-list 104. This guarantees that the matching process generates uniform results that can be quantitatively compared for generating the best fit or the best match.

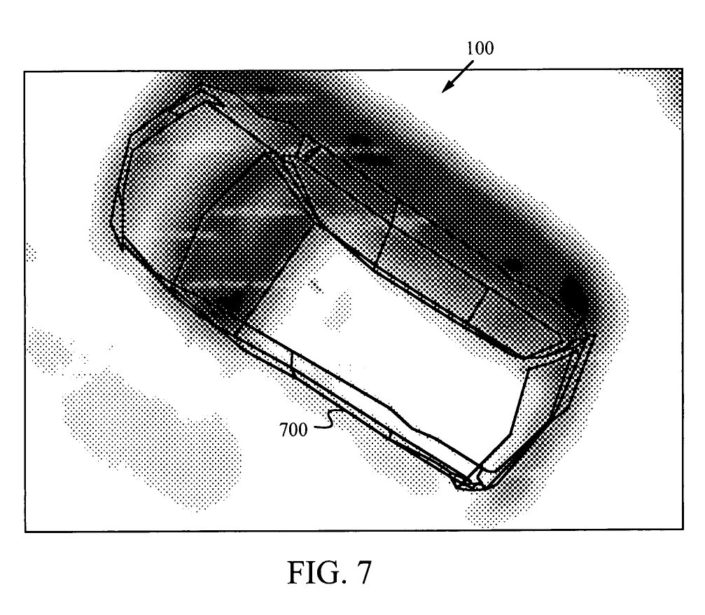

As points get matched they are constrained from moving. At any given point of the process some of the points on target vehicle will be constrained while some other may be allowed to be free to be moved within a certain tolerance limit. The displacement of the free points from their corresponding named points on comparison wire-frame model 280 constitutes an error. The final goal of this process is to arrive at a set of points that has the minimum total error and the fewest free points. It is an iterative process as it involves constraining some points at a time, freeing some others and calculating the displacement errors and repeating the process until all or nearly all combinations of constrained and free points have been exhausted. FIG. 7 shows a vehicle 100 enlarged from FIG. 6. FIG. 7 also shows a wire-frame model 700 of one of the vehicles from shortlist 106, being laid over on top of an aerial image of vehicle 100 as part of the said matching process.

The same comparison process is carried out over various wire-frame models 280 of vehicles in the short-list 104. As the process of identifying and marking points on an image of a target vehicle 100 depends to some level on the clarity, angle and/or resolution of the image, and resolution of the comparison wire-frame models, the iterative comparison process can have tolerance levels defined so that a target point that is within a certain threshold distance of a comparison point, as defined by the tolerance level, is considered to be matched. At the end of the matching process against one comparison wire-frame model 280, each point that was identified and marked on image of target vehicle 100 will have a result associated with it. The result for each point will normally be either a successful match to a corresponding point on said wire-frame model 280 or a failure to match to a corresponding point on said wire-frame model 280.

In addition to success and failure, the quantitative nature of the fitting of each point may also be available as one of various types of measures of similarity. For example, one measure of similarity is a displacement vector with one displacement value associated with each identified and marked point on target vehicle 100. A total displacement is simply the sum of absolute values of all the displacements in the displacement vector. A displacement standard deviation is simply the standard deviation of all the values in the displacement vector. In addition, a fit-ratio is simply a ratio of marked points on target vehicle 100 that successfully matched the corresponding points on comparison wire-frame model 280 to total number of marked points on target vehicle 100. The closer to 1 the fit-ratio is, the better the nature of the fit. In addition, a smaller total displacement corresponds to a better the quality of the fit. While a high fit-ratio indicates a more morphologically accurate match, a lower total displacement number may indicate a better quality match, if it is accompanied by a low displacement standard deviation. However, a low total displacement number may sometimes hide a large single displacement error and therefore may have a higher displacement standard deviation. Therefore, a high fit-ratio will take higher precedence in determination of a matched wire-frame model.

Once all the wire-frame models 280 in short-list 104 have been compared with identified and marked points on target vehicle 100, then various measures of similarity (e.g., a total displacement, displacement standard, deviation, and/or fit-ratio result) are available for each wire-frame model in the short list. The model that has the fit-ratio that is closest to 1 and has the lowest total displacement with the lowest displacement standard deviation can be selected to be the wire-frame model that uniquely matches the target vehicle 100. In more general terms, a model that has fit-ratio that is closest to 1 and that has lowest product of total displacement and displacement standard deviation can be selected as the model that best fits target vehicle 100. In case more than one wire-frame model is sufficiently similar to be selected as a match then all matching wire-frame models will be selected. Since the wire-frame models were made from known makes and models of vehicles, a matching wire-frame model indicates a matching make and model of a vehicle. Thus the result of the wire-frame comparison process is a matching make and model vehicle that most closely matches target vehicle 100, or a set of matching makes and models of vehicles that most closely match target vehicle 100.

Such fitting of target vehicle 100 to a pre-existing wire-frame model 280 can be done manually or using off-the-shelf products available in the marketplace. One such product is called Photomodeler. Such products are typically used to recreate accident scenes, or to recreate images of vehicles damaged in an accident or crime. In the present context, they are used in a process of identifying make and models of completely unknown vehicles by iterating the vehicle comparison process over a subset of likely matching vehicles. The identification process described in this preferred embodiment of the current invention works by narrowing down the set of likely matches of a target vehicle 100. A wire-frame model comparison is a step in that process, a step that can be best carried out when the set of likely matches has already been made computationally small by a previous step such as vehicle type categorization or vehicle maker categorization.

The next step in the flowchart, step 60, is to select a set 106 of vehicles out of shortlist 104, the selected set being the wire-frame models in the shortlist which most closely match the positions of marked points of target vehicle 100 as seen in FIG. 5. Since the comparison process involves dimensions of several points marked on the target vehicle 100, in most cases the comparison process will yield one clear closest match as member of set 106. However, it is possible due to various reasons to have more than one vehicle that has a wire-frame model closely matching the marked points of vehicle 100. In such cases, set 106 will contain more than one vehicle in it. It is also possible that none of the vehicles in shortlist 104 matches target vehicle 100 during said wire-frame comparison process, and set 106 will then be empty and vehicle identification process may either be declared to have failed or shortlist 104 may be expanded to include other vehicles in category 102 and the wire-frame matching process repeated.

Assuming that set 106 is non-empty, the next step in the process, step 65, is to further corroborate by other means the result of step 60. Step 65 can also be used to eliminate some of the vehicles in set 106 if set 106 contains more than one vehicle. Step 65 can also be used to more closely differentiate between members of set 106. A preferred method is to carry out a paint matching process on target vehicle 100. Color chips of existing vehicles, or similar information about special pigments, dyes, colors, and/or chemicals used in existing vehicles are available for comparison purposes in data store 67. In this process a color that best represents target vehicle 100 is picked from the image. The best representative color can be picked in many ways. For example, the color may be picked as an average of colors that are visible in some specific places on the body of vehicle 100, or it may be the color of a specific portion of target vehicle 100. The best representative color may also be a special pigment or a dye or a chemical that is visible only in some other and possibly invisible portion of the electromagnetic spectrum, such as infrared, or microwave, or x-rays etc. The best representative color of target vehicle 100 can then be compared using color matching tools to colors of pre-existing color chips of, or special pigments or dyes or chemicals that were known to have been used in vehicles belonging to set 106, or to color of pre-existing color chips of set of, or special pigments or dyes or chemicals that were known to have used in vehicles belonging to set 106 that are most likely to match target vehicle 100. Ageing factors may also be considered while comparing the two colors. The color test can corroborate findings from previous step, or help to further narrow down the candidate vehicles in the selected set of vehicles 106 that are most likely to match target vehicle 100. Certain specific colors that only very specific manufacturers used on specific models can be determined or eliminated from contention. Even a year of manufacture of a target vehicle 100 may be determined if some specific colors, pigments, dyes, or chemicals were used that year that were not used in some other years.

Sometimes, some colors, paints, dyes, chemicals, pigments, or metals used in vehicles respond differently to electromagnetic radiation in wavelengths other than visible light wavelengths. The spectral signatures of certain specialty colors, paints, dyes, chemicals, pigments, or metals, known to have been used in specific makes and models of vehicles can be measured and stored for comparison purposes. A hyper-spectral or multi-spectral image of a target vehicle may then be used to detect metals, paints, dyes, colors, chemicals, or pigments that respond to and reflect electromagnetic radiation in invisible portions of the spectrum or respond to multiple wavelengths of electromagnetic spectrum simultaneously. A comparison of what is observed in the hyper-spectral and/or multi-spectral image to known hyper-spectral and/or multi-spectral signatures of various makes and models of vehicles will further help to corroborate or to negate the findings of previous steps.

Another step of corroborating the results could involve looking for special features or front grilles of vehicles. If pictures of front grilles are available, they could be matched against known vehicle grille shapes to determine make, model or perhaps year of manufacture of target vehicle 100. Special features or front grilles of vehicles, for example, could similarly be used to eliminate certain vehicles from set of vehicles 106 that are most likely to match target vehicle 100.

The end result of this process, step 70, is a set 108 of vehicles, most likely containing a unique member, that contains one or more vehicle makes and models and possibly year information, that most closely match target vehicle 100.

In summary, the preferred embodiment includes a series of steps that progressively narrow down the set of likely matches of vehicles to a target vehicle 100 as part of a method of classification of vehicles to determine a make and model for the vehicle. The number of steps involved in the process is variable and depends upon the available data and requirements of match. The steps described above are a preferred embodiment of a possible combination of steps. It would be clear to one skill in the relevant art that there are many other possible ways of ordering of steps, and/or adding to or deleting from them without departing from the spirit and scope of the invention.

1. A method for vehicle classification comprising:
obtaining an image stored in digital format on computer-readable medium;
identifying the presence of a target vehicle in the image;
categorizing the target vehicle as belonging to a broad vehicle category selected from a predetermined set of broad vehicle types stored in a database;
creating a shortlist of vehicle makes and models in the broad vehicle category, wherein the shortlist contains makes and models that match one or more spatial vehicle characteristics of the target vehicle;
performing a computational wireframe matching between the target vehicle and wireframe models of the vehicle makes and models in the shortlist to produce a set of selected vehicle makes and models;
performing additional tests to narrow the set of selected vehicle makes and models to produce a final matching set of vehicle makes and models.

2. The method of claim 1 wherein identifying the presence of a target vehicle in the image comprises performing a computational image analysis to classify and cluster frequency responses in the image, including frequency responses associated with vehicles.

3. The method of claim 1 wherein identifying the presence of a target vehicle in the image comprises performing a computational feature extraction using a set of training set of vehicle data to identify the presence of the target vehicle in the image.

4. The method of claim 1 wherein the predetermined set of broad vehicle types stored in a database comprises at least one broad vehicle type selected from the group consisting of minivans, sedans, pickup trucks, recreational vehicles, and sports utility vehicles.

5. The method of claim 1 wherein identifying the presence of a target vehicle in the image comprises performing a computational edge-detection to identify edges in and around the target vehicle, and determining from the identified edges a set of spatial vehicle characteristics of the target vehicle.

6. The method of claim 1 wherein categorizing the target vehicle as belonging to a broad vehicle category comprises performing a computational comparison of spatial vehicle characteristics of the target vehicle with spatial vehicle characteristics stored in a database of vehicle makes and models.

7. The method of claim 6 wherein the spatial vehicle characteristics of the target vehicle comprise at least one spatial characteristic selected from the group consisting of vehicle length, vehicle width, internal edge length, and ratio of edge lengths.

8. The method of claim 1 wherein creating a shortlist of vehicle makes and models comprises performing a computational comparison of spatial vehicle characteristics of the target vehicle with spatial vehicle characteristics stored in a database of vehicle makes and models.

9. The method of claim 8 wherein performing the computational comparison of spatial vehicle characteristics comprises comparing at least one spatial characteristic selected from the group consisting of vehicle length, vehicle width, vehicle surface area, vehicle perimeter, roof surface area, roof perimeter, hood surface area, hood perimeter, window surface area, window perimeter, trunk surface area, and trunk perimeter.

10. The method of claim 1 wherein performing a computational wireframe matching comprises identifying points on the target vehicle and matching the identified points to corresponding points in the wireframe models of the vehicle makes and models in the shortlist.

11. wherein matching the identified points to corresponding points in the wireframe models comprises computationally rotating the wireframe models to various angles and comparing spatial distances between the identified points to spatial distances between the corresponding points in a projection of the rotated wireframe model.

12. The method of claim 1 wherein performing additional tests to narrow the set of selected vehicle makes and models comprises comparing target vehicle frequency responses detected in the image with frequency responses stored in a database of vehicle makes and models.
